(19) United States
(12) Patent Application Publication
(10) Pub. No.: US 2007/0224322 A1
(43) Pub. Date: Sep. 27, 2007

(54) USE OF NITROUS OXIDE (N2O) OR OF A MIXTURE OF GASES COMPRISING NITROUS OXIDE AS SWEETENER FOR AGROFOODS OR PHARMACEUTICAL PRODUCTS

(76) Inventors: Jacques Cutayar, Guyancourt (FR); Jean-Louis Pean, Montlhery (FR)

Correspondence Address: AIR LIQUIDE;Intellectual Property, 2700 POST OAK BOULEVARD, SUITE 1800, HOUSTON, TX, 77056, US

(21) Appl. No.: 11/670,456

(22) Filed: Feb. 2, 2007

Related U.S. Application Data
(63) Continuation-in-part of application No. 10/569,361.

(51) Int. Cl. A23L 1/236

(52) U.S. Cl. 426/548

(57) ABSTRACT

A method of preparing a product, in particular an agrofoods or pharmaceutical product, which comprises a step consisting of the addition of an agent with a sweetening power, characterized in that the agent with sweetening power consists, entirely or partly, of the incorporation into the product of a gas or mixture of gases comprising nitrous oxide N₂O, and in that one or more adjuvants are added to the composition of the product, which adjuvants make it possible to slow the kinetics of desorption of the gas or mixture of gases comprising nitrous oxide N₂O from said matrix once said gas or mixture of gases has been incorporated.

CROSS REFERENCE TO RELATED APPLICATIONS

This application claims the benefit of priority under 35 U.S.C. § 120 to U.S. application Ser. No. 10/569,361, filed internationally on Feb. 9, 2006, the entire contents of which are incorporated herein by reference.

### BACKGROUND

The invention relates to the field of the sweetening of products, in particular agrofoods, or alternatively pharmaceuticals, in particular drinks.

It is known that, in this industry, reference is generally made to “sweetening”, regardless of the agent added, “true” sugar (sucrose) or sweetener as present on approved lists, and reference is also sometimes made to the addition of a “sweetening agent”.

It is known that the sweetening power is the evaluation of the sweet nature in relation to sucrose.

More specifically, the power of sucrose is considered to be 1 (sometimes evaluated as base 100); if a product has a sweetening power of 50, it is then considered that this product is 50 times sweeter than sucrose.

Sweeteners generally have sweetening powers that range from 30 to 3000.

Technically, one can therefore say that a sweetener is a component that has a sweetening power and is energy-free. The term “intense sweetener” is sometimes used when the sweetening power is 30 to 3000 times greater than sucrose. However, in regulatory terms, “sweeteners” are well defined and present on a regulatory list, and if a product is not on the list, it is not recognized as a sweetening additive by the regulations.

The agrofoods industry has always been attempting to solve the following equation: eating with enjoyment but also eating a healthy diet. If one looks at consumer tendencies for a certain number of years, one notes, unfortunately, that malnutrition increasingly affects developed countries, the rate of obesity, which was first high in the United States, has never been so high in Europe and this phenomenon continues to develop.

Consumers have become used to consuming products in which sugar is a main component of the taste. The consumption of sugar per kg per year and per inhabitant has, what is more, also increased (sugar in the product but also sugar added by consumers to their products on their own initiative). One of the main sugars concerned is sucrose.

Thus, numerous steps are taken to limit the consumption of sugar, both in order to combat excess weight but also to limit the associated diseases (diabetes, obesity). The regulations require, for example, that the fat and sugar contents of agrofoods products be shown on labels, and industrial companies are increasingly promoting, through innovative products, the Anglo Saxon concept of “well-being”, i.e. eating a healthy diet.

The use of sweeteners in agrofoods products has been authorized since January 1988. These substances are characterized by virtue of their sweetening power, indicating the amount of sucrose used to reproduce an equivalent sweet taste. These substances can be of very diverse nature (sugars, sugar-alcohols, peptides, proteins, and the like) and have very different sweetening powers. Said sweetening power can vary depending on the concentration used.

The ideal sweetener has a high sweetening power; it is not expensive, must not have an unpleasant taste, must be stable throughout the lifetime of the product, and, of course, must have no harmful effect on the organism.

Mention may be made, here, of aspartame, acesulfame K, saccharine and its derivatives, etc., with sweetening powers that can range up to 350 times the sweetening power of sucrose.

Most sweeteners, regardless of whether or not they are synthetic, leave a lasting impression on the sensory apparatus, hence the persistence of a prolonged sweet taste, sometimes until one feels sick. In addition, the complete elimination of sucrose to the benefit of the sweetener causes, in general, a loss of the effect of fullness of the product in the mouth (less thickness, roundness to the taste in the mouth). Moreover, some sweeteners are unstable (to heat, in acidic medium) or develop unpleasant tastes (bitterness, metal taste). The cost also represents a considerable drawback to their use. Finally, it will be noted that some of them may be responsible for adverse effects on the consumer: allergenic, toxic, or even carcinogenic, and may be subject to limiting doses for use in products, or even prohibited in the formulation of certain products intended in particular for infants.

It can therefore clearly be seen that there is no ideal sweetener.

One may also point out the problems that the pharmaceutical industry has in sweetening medicaments intended for diabetics, without forgetting the problems of taste of certain syrups, in particular for children.

One of the objectives of the present invention is therefore to propose a new solution that makes it possible to sweeten food or pharmaceutical products, by providing a technical solution to all or some of the drawbacks mentioned above.

As will be seen in greater detail below, the invention proposes to use nitrous oxide N₂O or a mixture of gases containing N₂O (optionally mixed with CO₂) as an agent with a sweetening power that can be used as an additive for agrofoods or pharmaceutical products, in particular for liquid products, especially drinks.

As will also be seen below, one of the objectives of the present invention was to optimize the incorporation of nitrous oxide (optionally mixed with carbon dioxide) into the medium under consideration, in order to give it an optimal sweetening power (and, where appropriate, carbonation). This involves a reduction in the rate of desorption of these gases, and therefore an improvement in their stability once dissolved in the medium under consideration, for example the drink. For organoleptic reasons, the nitrous oxide is advantageously combined with carbon dioxide (CO₂). This is because carbon dioxide provides an acidity that improves the perception in the mouth.

As will also be seen below, the trials carried out, in particular on drinks such as sodas, flavored mineral waters, or alternatively milk-based products, show, unambiguously and extraordinarily surprising, that N₂O can be used as a sweetener under the desired conditions and with the desired performance levels, its sweetening power possibly reaching, depending on the conditions of use, up to the equivalent of 50 g sucrose/liter under normal conditions of use (saturation Pₘₐₓ at 3 atmospheres). If the desired sweetening power is greater than 40-50 g sucrose/liter, the N₂O will then preferably be combined with another sweetening source. In this case, synergies between the N₂O and the sweetening agent can vary depending on the sugar/the sweetener used.

In this case, synergies of different intensity have been noted between, firstly, N₂O and, secondly, the sucrose or the sweeteners, in particular with aspartame.

It should be emphasized that nitrous oxide is commonly used in agrofoods. It clearly appears to be an additive which is generally accepted in all food products under the code E942, sometimes with the following description “propellant gas”, and among known uses, mention may therefore be made of the “propellant gas” effect (for example, for products in a pressurized can, such as chantilly cream), gases used for packaging products under a modified atmosphere (fruit and vegetables, preparation for patisseries, etc.), gases studied and sometimes used in the overrunning of food mousses or ices, etc.

However, never in the past has a power of a product sweetening agent been mentioned or even suggested under conditions in which the stability of the gas is sufficient once dissolved in the medium under consideration, for example the drink, such that the sweetening power changes as little as possible over time.

The present invention has therefore in particular focused on solving this stability problem.

The present invention therefore relates to a method of preparing a product, in particular an agrofoods or pharmaceutical product, which has a composition that comprises a liquid or semi-liquid matrix, the method comprising a step consisting of the addition of an agent with a sweetening power, and being characterized in that the agent with sweetening power consists, entirely or partly, of the incorporation into the product of a gas or mixture of gases comprising nitrous oxide N₂O, and in that one or more adjuvants are added to the composition of the product, which adjuvants make it possible to slow the kinetics of desorption of said gas or mixture of gases comprising nitrous oxide N₂O from said matrix once said gas or mixture of gases has been incorporated.

By virtue of its sweetening power and by virtue of its absence of energy, it may be considered that the gas or mixture of gases comprising nitrous oxide N₂O added according to the invention has the properties of a sweetener.

The method according to the invention may, moreover, adopt one or more of the following technical characteristics:
at least one of said adjuvants is part of the monosaccharide group,
at least one of said adjuvants is part of the group consisting of fructose, polyols such as mannitol, sorbose,
at least one of said adjuvants is part of the polysaccharide group,
at least one of said adjuvants is part of the group consisting of pectins, starch, carraghenates, gums (such as Arabic, guar, dextran, xanthan),
at least one of said adjuvants is part of the amino acid group,
at least one of said adjuvants is part of the group consisting of proline, serine, and valine.

Moreover, studies carried out by the applicant have made it possible to demonstrate other very interesting results: these results illustrate the fact that faced with a solubility of N₂O (measured as volume of gas dissolved per volume of liquid at 1 bar absolute) in distilled water in the region of 0.53 at 20° C., the solubility in a cream containing 36% fat at 20° C. is equal to 1, and the solubilities in corn oil, in olive oil and in soybean oil are respectively equal to 1.70 at 25° C., 1.40 at 20° C. and 1.80 at 25° C. This means that, for certain products, the presence (or the introduction if necessary) of one or more fat(s) will make it possible, overall, to incorporate, into the product under consideration, more N₂O than would be possible if this or these fat(s) was (were) not present. This will make it possible to increase, overall, the sweetening effect and to facilitate the stabilization of the nitrous oxide incorporated.

Logically, use will preferably be made of such an implementation for products for which (or to which) a fatty phase dispersed in an aqueous or semi-aqueous liquid phase is already present (or can be added), for example as is the case of yoghurts, milk drinks, or alternatively ice creams.

Consequently, according to one of the implementations of the invention, the product under consideration comprises a fatty phase in said liquid or semi-liquid matrix.

According to another of the implementations of the invention, a fatty phase is added to said liquid or semi-liquid matrix before incorporation of said gas or mixture of gases comprising N₂O.

According to yet another of the implementations of the invention, said incorporation of said gas or mixture of gases is carried out in the following way:
an adjacent fatty phase not present in said initial composition of the product is provided;
said incorporation of said gas or mixture of gases is carried out into said adjacent fatty phase;
this adjacent fatty phase rendered “nitrous oxide-comprising” in this way is incorporated into said composition so as to form said product.

The method according to the invention may, moreover, adopt one or more of the following technical characteristics:
said gas consists of N₂O alone;
said gas consists of N₂O as a mixture with CO₂;
said gas consists of N₂O as a mixture with one or more gas(es) authorized for use as an agrofoods or pharmaceutical product ingredient or additive;
the sweetening agent consists only in part of the incorporation into the product of said gas or mixture of gases, due to the fact that a conventional sweetening agent is also incorporated into the product;
the conventional sweetening agent incorporated is a sugar or a sweetener or a mixture thereof;
the product prepared is a liquid;
the product prepared is a drink;
the product prepared is a milk drink;
the product prepared is a soft product;
the product prepared is an overrun product;
the product prepared is a solid product into which the gas or mixture of gases containing nitrous oxide is incorporated during one of the steps of its preparation.

Other characteristics and advantages will emerge from the following description, which gives details below of numerous trial results.

In the Case of a Drink of Flavored Soda Type

The evaluation of the sweetening power of N₂O was carried out through the following trials:
evaluation of the sweetening by N₂O alone,
evaluation of the sweetening by N₂O +sucrose,
evaluation of the sweetening by N₂O +sucrose and N₂O +sweeteners.

A flavored soda-type drink (carbonated with from 3.5 to 4 g CO₂/liter−approximately 2 bar of CO₂ at 15° C.) was used as carrier for the trials.

Evaluation of the Sweetening Power of N₂O Alone

Organization of the Trials
Drink with no sugar introduced.
Drink saturated (at 10° C.) with N₂O/CO₂ mixtures under various pressures.

Solubility of N₂O and of CO₂ in the Drink in mg/l/bar:

| Temp° C. | CO₂ | N₂O |
|---|---|---|
| 5° C. | 2535 | 1895 |
| 10° C. | 2135 | 1575 |
| 15° C. | 1820 | 1325 |
| 20° C. | 1565 | 1125 |

Trials Carried Out

| | |
|---|---|
| Saturation | |
| pressure | % N₂O/CO₂ of the mixtures of gases used |

| (atmospheres) | 100 | 90/10 | 80/20 | 60/40 |
|---|---|---|---|---|
| 1 | | X | X | X |
| 2 | | X | X | X |
| 3 | | X | X | X |
| 4 | X | | | |
| 5 | | | X | |

Summary of Results

The products were tasted by a sensory analysis panel:
The sweetening power of N₂O was clearly identified.
N₂O used alone has a considerable sweetening power, but that is sometimes judged to be persistent or sickly.
On the other hand, the N₂O+CO₂ combination is beneficial, the “salty” flavor of CO₂ making it possible to advantageously reequilibrate the sweet profile of the N₂O.
The desorption of N₂O alone is rapid in the form of large bubbles.
The product given the highest approval is that which is saturated, under 3 bar absolute, with a mixture of 80% N₂O and 20% CO₂, and for which the sugar equivalent is estimated at approximately 30 g sucrose/liter.
The use of N₂O alone confers on the product a sweetening power evaluated at 40 g sucrose/liter.
   Evaluation of the Sweetening Power of N₂O Combined With Sucrose

Organization of the Trials
Drink with no sugar introduced.

Drink saturated (at 10° C.) according to the following matrix:

| | Control | Trial 1 | T2 | T3 | T4 | T5 |
|---|---|---|---|---|---|---|
| Sucrose (g/l) | 30 | 30 | 30 | 30 | 30 | 30 |
| % N₂O/CO₂ | 0/100 | 100/0 | 80/20 | 70/30 | 60/40 | 50/50 |
| mixtures of | | | | | | |
| gases | | | | | | |
| Saturation | 3 | 3 | 3 | 3 | 3 | 3 |
| pressure in | | | | | | |
| bar absolute | | | | | | |

Summary of Results

The products were tasted by a sensory analysis panel:
T2 and T3 are the products given the highest approval, they present a good compromise between, firstly, strength and balance of the sweetening, and desorption quality.
The sweetening is judged to be correct, slightly less than that of the standard product (control sweetened at 90 g of sucrose/l).
N₂O and sucrose have a synergistic effect; the product aerated under 3 bar of 80% N₂O−20% CO₂ mixture exhibits a sweetening evaluated at approximately 80 g/l of sucrose for a product containing only 30.

The proportion of the sweetening provided by the N₂O is therefore evaluated at 50 g of sucrose/liter, whereas it had been evaluated at 30 g of sucrose/liter under the conditions of the preceding trial.

Evaluation of the Sweetening Power of N₂O Combined With Sweeteners

Trial set up to evaluate the sweetening effect of N₂O combined with sweeteners (aspartame and acesulfame K).

The sweetening powers of aspartame and of acesulfame K are judged to be equivalent to 200.

A sweetening profile is characterized through 3 notes:
a top note
a heart note
a bottom note.

Sucrose, aspartame, and acesulfame K are complementary:
Aspartame has a considerable top note, the sweetening flavor then decreases rapidly but exhibits considerable persistence after swallowing.
Sucrose has a dominant heart note.
Acesulfame K is characterized by a strong bottom note, associated with a metallic aftertaste.

Organization of the Trials
Drink with no sugar introduced.

Drink saturated (at 10° C.) according to the following matrix:

| | Tl | T2 | T3 | T4 | T5 | T6 |
|---|---|---|---|---|---|---|
| Sucrose (g/l) | 0 | 0 | 0 | 0 | 30 | 30 |
| Aspartame (ppm) | 150 | 150 | 0 | 0 | 0 | 0 |
| Acesulfame K | 0 | 0 | 150 | 150 | 0 | 0 |
| (ppm) | | | | | | |
| % N₂O/CO₂ | 70/30 | 80/20 | 70/30 | 80/20 | 70/30 | 80/20 |
| mixtures of gases | | | | | | |
| Saturation | 3 | 3 | 3 | 3 | 3 | 3 |
| pressure in | | | | | | |
| bar absolute | | | | | | |

Summary of Results

The products were tasted by a sensory analysis panel:
The remarks formulated with regard to the products containing sucrose are identical to those formulated during the preceding trial; the sweetening is again evaluated at approximately 80 g of sucrose/liter, slightly less than the standard sweetening (90 g of sucrose/liter).
In general, the products containing sweeteners are all judged to be sweeter than normal. Their sweetening is evaluated at 110 g of sucrose/liter. The combination of N₂O and sweetener therefore appears to exhibit an even greater synergy; the power of N₂O can, in this case, be estimated at 80 g of sucrose/liter for a product alone evaluated at 30 g of sucrose/liter during the preceding trial.
The 70/30 mixtures appear to be preferred for the product under consideration.
The N₂O/aspartame combination appears to be preferred.
The use of N₂O combined with aspartame in the complete absence of sucrose maintains the effect of fullness in the mouth (thickness and roundness to the taste in the mouth).

Other trials were carried out on a flavored sparkling mineral water and on unsweetened natural drinking yoghurt, both recognized for being highly astringent to the taste. They are summarized hereinafter.

Flavored Mineral Water

Organization of the Trials

The water bottles are partially de-aerated at 13° C. and re-aerated with N₂O up to 2 bar (in other words, they are partially de-aerated so as to then attain, after the addition of N₂O, the targeted CO₂/N₂O ratio).

The products proposed for evaluation are as follows:

| | |
|---|---|
| T1: 0.5 b N₂O/1.5 b CO₂ | (25% N₂O/75% CO₂) |
| T2: 1 b N₂O/1 b CO₂ | (50% N₂O/50% CO₂) |
| T3: 1.5 b N₂O/0.5 b CO₂ | (75% N₂O/25% CO₂) |

Control: standard sparkling mineral water aerated at 2 bar of CO₂.

Summary of Results

The products were tasted by a sensory analysis panel (9 individuals), and a classification by order of preference (scores of 1 (very well liked) to 4 (not really liked)) was carried out.

| | | | | | | | | | | |
|---|---|---|---|---|---|---|---|---|---|---|
| Control | 1 | 1 | 3 | 4 | 2 | 2 | 4 | 1 | 1 = | 22 |
| T1 | 4 | 1 | 3 | 3 | 3 | 4 | 2 | 3 | 2 = | 25 |
| T2 | 2 | 1 | 2 | 2 | 1 | 1 | 1 | 2 | 1 = | 13 |
| T3 | 3 | 1 | 1 | 1 | 4 | 3 | 2 | 4 | 3 = | 22 |

The product aerated at 50% N₂O/50% CO₂ is clearly preferred to the product of origin. This preference is due to a feeling of softness that reduces the astringency of the product.

The other two products are not apparently preferred to the product of origin:

Since the first product (25% N₂O/75% CO₂) is not judged to be different by the tasters, it may be assumed that the amount of N₂O is probably insufficient to modify the astringent nature of the product.

The last product (75% N₂O/25% CO₂) is rejected, probably due to a problem of N₂O desorption characterized by a feeling of expansion in the mouth. It is also judged to be “flat” since it does not contain enough CO₂.

Unsweetened Natural Drinking Yoghurt

Organization of the Trials

The products proposed are the following:

| | Control | T1 | T2 | T3 | T4 |
|---|---|---|---|---|---|
| Temp° C. | 15° C. | 15° C. | 15° C. | 15° C. | 15° C. |
| Atmosphere | Air | Air | Air | N₂O | N₂O |
| Saturation | 0 | 1 | 1 | 1 | 1.8 |
| pressure in | | | | | |
| relative bar | | | | | |
| Sucrose (g/l) | 0 | 0 | 20 | 0 | 0 |

Summary of Results

Here again, the products were tasted by a sensory analysis panel (9 individuals) and classification by order of preference (scores of 1 (very well liked) to 5 (not really liked)) was carried out.

| | | | | | | | | | | |
|---|---|---|---|---|---|---|---|---|---|---|
| Control | 4 | 4 | 3 | 4 | 4 | 4 | 4 | 4 | 4 = | 34 |
| T1 | 2 | 3 | 4 | 3 | 2 | 3 | 4 | 3 | 3 = | 27 |
| T2 | 1 | 1 | 1 | 1 | 1 | 1 | 1 | 1 | 1 = | 9 |
| T3 | 2 | 2 | 2 | 2 | 2 | 2 | 2 | 2 | 2 = | 18 |

| | |
|---|---|
| T4 | PROBLEM OF FOAMING WHEN OPENED |

It is not desirable to exceed saturation pressures of 2 bar.
The product containing sucrose is the most well liked; the least well liked is the unmodified product.
The sucrose-based product has a higher sweetening power than the product containing 1 bar of N₂O. The dosage of sucrose was fixed without knowing the solubility of N₂O in the yoghurt, i.e. without having been able to determine in advance the sweetening power corresponding to a pressurization of 1 bar of N₂O.
Be that as it may, the product containing 1 bar of N₂O is preferred to the base product and to the base product aerated with air.
A slight overrunning is well liked.
The product was judged to be smoother compared to the original product, through the use of N₂O.

Even more trials, carried out on neutral or flavored (vanilla, for example) overrun dessert products of milk-based mousse type, made it possible to confirm these elements.

In summary, the examples given in detail above made it possible to demonstrate unambiguously and in a manner entirely new for this industrial sector, that N₂O possesses, under selected conditions of use, to be adjusted to each product of course, some of which are presented through the present description, sweetening powers.

The sweetening power of N₂O is demonstrated as a substitution, as appropriate, for all or some of the sucrose.

In certain applications, it will be usefully employed in synergy with CO₂ or with any other gas authorized for use as an ingredient or additive of agrofoods or pharmaceutical products or of the legislation of the industry concerned, which will make it possible both to reequilibrate the sweetening profile and also, in the case of drinks, to aid in the control of its desorption, the proportions of one and of the other being variable according to the products.

For high sweetening powers, it will advantageously be supplemented with sucrose or any other sweetening agent that those skilled in the art may use in small proportions.

Synergistic effects of the N₂O/sucrose and even more so the N₂O/sweetener combination were demonstrated.

In the complete absence of sugar, the N₂O added compensates favorably for the loss of fullness of the product, which conserves its thickness and its roundness in the mouth.

In addition, used pure or as a mixture with CO₂ or any other gas authorized for use as an ingredient or additive according to the legislation of the industry concerned, the N₂O softens the organoleptic profile of the product (bitterness, astringency, etc.), and in this case, it may be envisaged to bring the saturation to 1 atmosphere or even to accept a slight overrunning of the product.

Slowing of the Rate of Desorption of the Nitrous Oxide by Adding Adjuvants:

A study was carried out to show how the introduction of adjuvants into the liquid matrix modifies the retention of the dissolved CO₂ and N₂O.

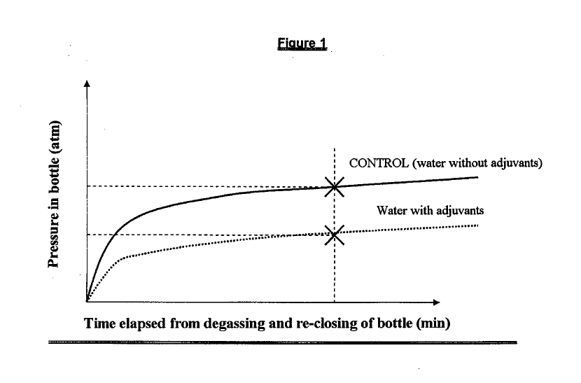

Trials were thus carried out on 900 ml of demineralized water at 9° C., saturated at a pressure of approximately 3 bar with pure CO₂ or pure N₂O (firstly), and supplemented with varying amounts of certain adjuvants (monosaccharides, polysaccharides, amino acids). The rate of desorption of the gases dissolved in a matrix without adjuvants (control) and with adjuvants was compared. The graph presented in FIG. 1 attached below shows, by way of indication, the temporal evolution of the pressure observed in the bottle after opening (degassing) and from the re-closing of the bottle: at degassing, the pressure in the bottle is equal to atmospheric pressure (relative internal pressure zero), and as soon as the bottle is closed, the dissolved gases desorb more or less rapidly, which causes the pressure to increase. We evaluate the tendency of the gases to desorb by comparing the pressure 30 minutes after re-closing in the case of the control and in the case with matrix with added adjuvant.

In the Case of MONOSACCHARIDES

It was demonstrated that the addition to the liquid of a small amount (0.1 g) of fructose has virtually no influence on the rate of desorption of the CO₂, whereas, at larger amounts (5 g), the rate of desorption greatly decreases, with a pressure reduced by 50% compared to the control after degassing and a 30-minute wait after closing of the bottle. In the case of N₂O, conversely, very small amounts (0.1 g) of fructose are sufficient to reduce the pressure by approximately 50% after 30 minutes, and much larger dissolved amounts (5 g) do not cause this pressure to decrease proportionally.

The addition of mannitol reduces the rate of desorption of CO₂ and of N₂O, but only at very low concentrations, the pressure in the bottle after degassing and a 30-minute wait after closure being approximately 30% that for the control for a concentration of 0.1 g and 60% for a concentration of 0.2 g.

The addition of sorbose reduces the rate of desorption of CO₂ and of N₂O in a comparable manner already at low amounts: at 0.1 g, the pressure in the bottle after 30 minutes is approximately 40% that for the control; at 0.2 g, the pressure drops to approximately 30% of the control.

Overall, for the same mass (0.1 g) of monosaccharide, it appears that mannitol and sorbose retain CO₂ more than fructose. In the case of N₂O, very small amounts of fructose make it possible to considerably reduce the desorption, which is very advantageous for the application to still water.

In the Case of POLYSACCHARIDES

Weakly methylated pectins retain CO₂ more effectively than highly methylated pectins, at an equal amount (0.1 g): the pressure after 30 minutes being respectively 50% and 80% of the control. In the case of N₂O, the two types of pectins have the same effect after 30 minutes (40% of the pressure of the control). This behavior is advantageous, in particular, in the case of citrus drinks.

Starch decreases the rate of desorption of CO₂ and of N₂O. The amount of starch present in the liquid phase does not appear to influence the rate of desorption of N₂O (pressure after 30 minutes at 25% of the control at 0.1 g and 0.2 g). On the other hand, when the mass of starch increases, the rate of desorption of CO₂ decreases (pressure at 80% of the control at 0.1 g and 50% of the control at 0.2 g).

Lambda-carraghenate (0.1 g) reduces the rate of desorption of CO₂ (pressure at 50% of the control after 30 minutes), whereas kappa-carraghenate (0.1 g) increases the rate of desorption (pressure at 130% of the control after 30 minutes). On the other hand, lambda-carraghenates (0.1 g) have virtually no effect on the desorption of N₂O and kappa-carraghenates (0.1 g) reduce the desorption thereof (40% of the pressure of the control after 30 minutes).

The presence of 0.1 g of gum (gum Arabic, guar gum, dextran gum) has virtually no effect on the desorption of CO₂. This desorption decreases when the amount of gum increases. Xanthan gum gives different results: at 0.1 g, the pressure after 30 minutes is 30% that of the control, and 80% with 0.2 g. For N₂O, the presence of small amounts of gum Arabic, guar gum and dextran gum causes a considerable decrease in the desorption, larger amounts having only a limited impact. Xanthan gum behaves as for CO₂ (0.1 g giving a pressure after 30 minutes of 25% of the control, and 0.2 g a pressure comparable to the control).

In the Case of AMINO ACIDS

Three amino acids were tested: proline, serine, and valine. For the same mass of amino acid (0.1 g), serine slows the desorption more than valine and proline (in order). This is true for CO₂ and N₂O.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A method of preparing a product, in particular an agrofoods or pharmaceutical product, which has a composition that comprises a liquid or semi-liquid matrix, the method comprising a step consisting of the addition of an agent with a sweetening power, wherein the agent with sweetening power consists, entirely or partly, of the incorporation into the product of a gas or mixture of gases comprising nitrous oxide N₂O, and in that one or more adjuvants are added to the composition of the product, which adjuvants make it possible to slow the kinetics of desorption of the gas or mixture of gases comprising nitrous oxide N₂O from said matrix once said gas or mixture of gases has been incorporated.

2. The method of preparing a product according to claim 24, wherein at least one of said adjuvants is part of the monosaccharide group.

3. The method of preparing a product according to claim 25, wherein at least one of said adjuvants is part of the group consisting of fructose, polyols such as mannitol, sorbose.

4. The method of preparing a product according to claim 24, wherein at least one of said adjuvants is part of the polysaccharide group.

5. The method of preparing a product according to claim 27, wherein at least one of said adjuvants is part of the group consisting of pectins, starch, carraghenates, gums such as Arabic, guar, dextran, and xanthan.

6. The method of preparing a product according to claim 24, wherein at least one of said adjuvants is part of the amino acid group.

7. The method of preparing a product according to claim 29, wherein at least one of said adjuvants is part of the group consisting of proline, serine, and valine.

8. The method of preparing a product according to claim 24, wherein said composition comprises a fatty phase in said liquid or semi-liquid matrix.

9. The method of preparing a product according to claim 24, wherein at least one of said adjuvants is a fatty phase added to said liquid or semi-liquid matrix before incorporation of said gas or mixture of gases comprising N₂O.

10. The method of preparing a product according to claim 24, wherein said incorporation of said gas or mixture of gases is carried out in the following way:
a) an adjacent fatty phase not present in said initial composition of the product is provided;
b) said incorporation of said gas or mixture of gases is carried out into said adjacent fatty phase;
c) this adjacent fatty phase rendered “nitrous oxide-comprising” in this way is incorporated into said composition so as to form said product.

11. The method of preparing a product according to claim 24, wherein said gas consists of N₂O alone.

12. The method of producing a product according to claim 24, wherein said gas consists of N₂O as a mixture with CO₂.

13. The method of preparing a product according to claim 24, wherein said gas consists of N₂O as a mixture with one or more gas(es) authorized by the regulations for use as an agrofoods or pharmaceutical product ingredient or additive.

14. The method of preparing a product according to claim 24, wherein the sweetening agent consists only in part of the incorporation of said gas or mixture of gases, due to the fact that a conventional sweetening agent is also incorporated into the product.

15. The method of preparing a product according to claim 37, wherein the conventional sweetening agent incorporated is a sugar or a sweetener or a mixture thereof.

16. The method of preparing a product according to claim 24, wherein the product prepared is a liquid.

17. The method of preparing a product according to claim 39, wherein the product prepared is a drink.

18. The method of preparing a product according to claim 40, wherein the product prepared is a milk drink.

19. The method of preparing a product according to claim 24, wherein the product prepared is a soft product.

20. The method of preparing a product according to claim 42, wherein the product prepared is an overrun product.

21. The method of preparing a product according to claim 24, wherein the product prepared is a part of the group of yoghurts or of ice creams.

22. The method of preparing a product according to claim 24, wherein the product prepared is a solid product into which the gas or mixture of gases containing nitrous oxide is incorporated during one of the steps of its preparation.

23. A product obtained by means of claim 24.
